(19) United States
(12) Patent Application Publication
(10) Pub. No.: US 2025/0294100 A1
(43) Pub. Date: Sep. 18, 2025

(54) IMAGE PROCESSING SYSTEM, NON-TRANSITORY COMPUTER READABLE MEDIUM STORING PROGRAM, AND IMAGE PROCESSING METHOD

(71) Applicant: FUJIFILM Business Innovation Corp., Tokyo (JP)

(72) Inventors: Michihisa NEZU, Kanagawa (JP); Akiyoshi OSUGI, Kanagawa (JP); Ryoto SHIRASAKA, Kanagawa (JP); Goro NODA, Kanagawa (JP)

(73) Assignee: FUJIFILM Business Innovation Corp., Tokyo (JP)

(21) Appl. No.: 18/799,683

(22) Filed: Aug. 9, 2024

(30) Foreign Application Priority Data
Mar. 18, 2024 (JP) 2024-042850

(51) Int. Cl. H04N 1/00

(52) U.S. Cl. CPC H04N 1/00076; H04N 1/00832; H04N 2201/0094

(57) ABSTRACT

An image processing system includes: an image processing unit including at least one of a scanning device that scans an image or a printing device that prints the image on a medium; a display unit that displays a screen; a main processor; a sub-processor configured to perform control of the image processing unit independently of the main processor; and a shared memory that is accessible in common to the main processor and the sub-processor, in which the main processor is configured to record a history in the shared memory for each processing in startup processing of the image processing system, and the sub-processor is configured to, in a case where the startup processing by the main processor has stopped before the display unit becomes usable in the startup processing, refer to information including at least the history recorded in the shared memory to issue a notification of an error content by using the image processing unit.

### CROSS-REFERENCE TO RELATED APPLICATIONS

This application is based on and claims priority under 35 USC 119 from Japanese Patent Application No. 2024-042850 filed Mar. 18, 2024.

### BACKGROUND

### (i) Technical Field

The present disclosure relates to an image processing system, a non-transitory computer readable medium storing a program, and an image processing method.

### (ii) Related Art

JP2005-092463A discloses an image forming apparatus in which malfunction information and malfunction repair information are stored in an image forming apparatus body to improve convenience for a user in managing malfunctions.

JP2012-247119A discloses an air conditioner that displays a total number of locations where an abnormality has occurred, abnormality information of the locations, and the like by using a limited number of display elements provided in an indoor unit to display an operating status, in order to perform prompt and accurate repairs.

### SUMMARY

Aspects of non-limiting embodiments of the present disclosure relate to an image processing system, a non-transitory computer readable medium storing a program, and an image processing method that are capable of issuing a notification of an error content in a case where an error stop has occurred before a display unit becomes usable at startup.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing system including: an image processing unit including at least one of a scanning device that scans an image or a printing device that prints the image on a medium; a display unit that displays a screen; a main processor; a sub-processor configured to perform control of the image processing unit independently of the main processor; and a shared memory that is accessible in common to the main processor and the sub-processor, in which the main processor is configured to record a history in the shared memory for each processing in startup processing of the image processing system, and the sub-processor is configured to, in a case where the startup processing by the main processor has stopped before the display unit becomes usable in the startup processing, refer to information including at least the history recorded in the shared memory to issue a notification of an error content by using the image processing unit.

### BRIEF DESCRIPTION OF THE DRAWINGS

Exemplary embodiment(s) of the present invention will be described in detail based on the following figures, wherein:

FIG. 1 is an external view of an image forming apparatus of one exemplary embodiment of the present disclosure;

FIG. 2 is a side view showing a schematic configuration of a transparent document platen and a periphery of a document platen cover of the image forming apparatus, in which a part (A) in FIG. 2 is a view showing a fully open state of the document platen cover, a part (B) in FIG. 2 is a view showing a half-closed state of the document platen cover, and a part (C) in FIG. 2 is a view showing a fully closed state of the document platen cover;

FIG. 3 is a top view showing a schematic configuration of a periphery of the transparent document platen of the image forming apparatus;

FIG. 4 is a block diagram showing a hardware configuration of the image forming apparatus;

FIG. 5 is a diagram showing an example of a management table for managing detailed information for each processing in startup processing;

FIG. 6 is a diagram illustrating processing during the startup processing;

FIG. 7 is a diagram illustrating a lighting pattern of a carriage;

FIG. 8 is a diagram showing a printing example of a medium in a case of error occurrence;

FIG. 9 is a flowchart showing a flow of processing during the startup processing in a main CPU;

FIG. 10 is a flowchart showing a flow of processing during the startup processing in a scanning device sub-CPU; and

FIG. 11 is a flowchart showing a flow of processing during the startup processing in a printing device sub-CPU.

### DETAILED DESCRIPTION

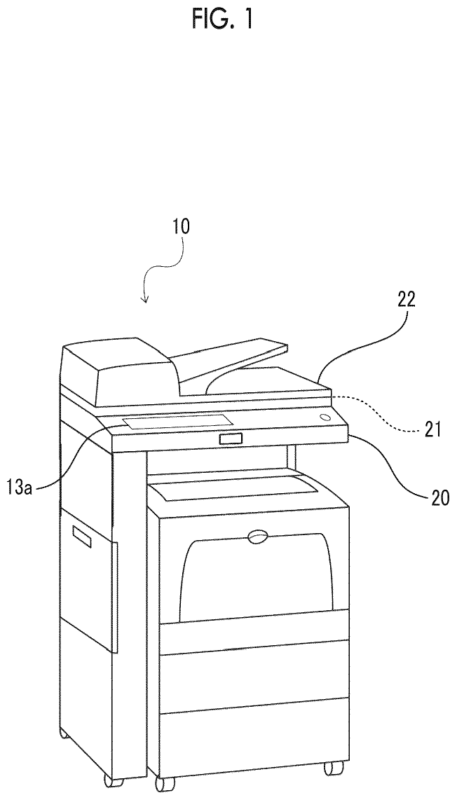

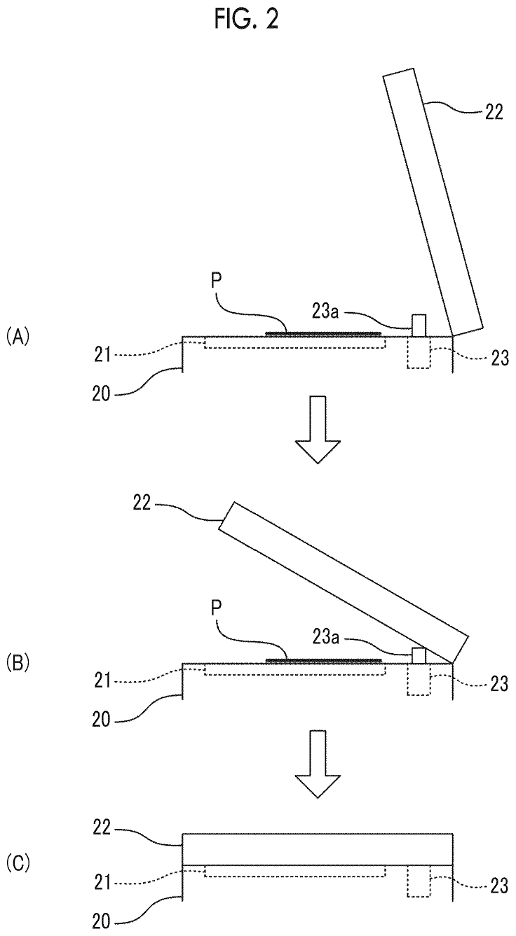

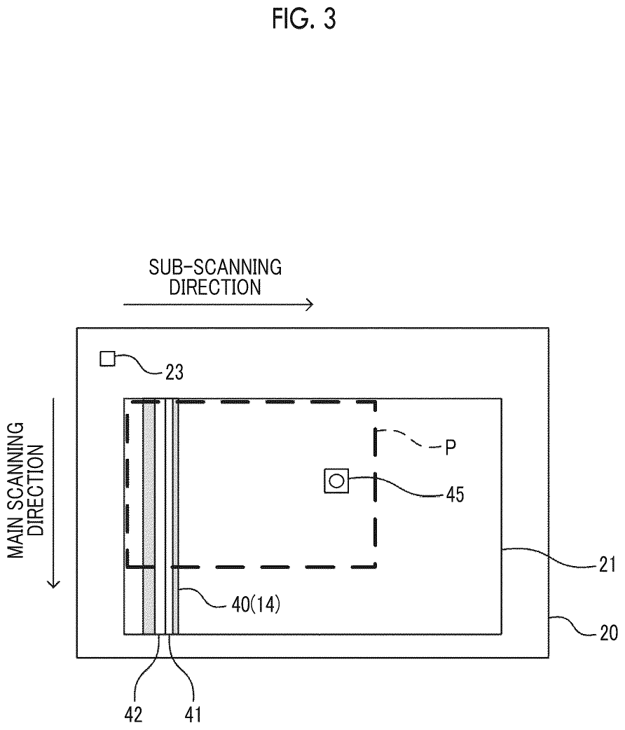

Hereinafter, exemplary embodiments of the present disclosure will be described in detail with reference to drawings. FIG. 1 is an external view of an image forming apparatus 10 of one exemplary embodiment of the present disclosure. FIG. 2 is a side view showing a schematic configuration of a transparent document platen 21 and a periphery of a document platen cover 22 of the image forming apparatus 10, in which a part (A) in FIG. 2 is a view showing a fully open state of the document platen cover 22, a part (B) in FIG. 2 is a view showing a half-closed state of the document platen cover 22, and a part (C) in FIG. 2 is a view showing a fully closed state of the document platen cover 22. FIG. 3 is a top view showing a schematic configuration of a periphery of the transparent document platen 21 of the image forming apparatus 10.

As shown in FIG. 1, the image forming apparatus 10 is an apparatus called a so-called multifunction peripheral having a plurality of functions such as a scanning function, a printing function, a copying function, and a facsimile function. The image forming apparatus 10 is an example of an image processing system in the technology of the present disclosure.

As shown in FIGS. 1 and 2, the image forming apparatus 10 includes a housing 20, the transparent document platen 21 that is disposed on an upper surface of the housing 20 and on which a document P is placed, the document platen cover 22 that covers the transparent document platen 21, and an opening/closing detection sensor 23 that detects an open/closed state of the document platen cover 22.

The opening/closing detection sensor 23 includes a push switch 23a that comes into contact with the document platen cover 22 in a case where the document platen cover 22 is closed. The opening/closing detection sensor 23 is a sensor capable of detecting two stages: a first detection position where the push switch 23a is pressed to a predetermined degree; and a second detection position where the push switch 23a is fully pressed.

A state in which the document platen cover 22 presses the push switch 23a to the first detection position is a half-closed position of the document platen cover 22. In the present disclosure, the half-closed position of the document platen cover 22 is a position between a fully open position and a fully closed position of the document platen cover 22 and is not limited to a central position between the fully open position and the fully closed position.

By using such an opening/closing detection sensor 23, the image forming apparatus 10 can detect three open/closed states of the document platen cover 22: a state in which the document platen cover 22 is open further than the half-closed position; a state in which the document platen cover 22 is closed further than the half-closed position; and a state in which the document platen cover 22 is fully closed.

In addition, as shown in FIG. 3, the image forming apparatus 10 includes a scanning device 14 and a document detection sensor 45.

The scanning device 14 includes a carriage 40 that is movable in a sub-scanning direction. The carriage 40 includes a light source 41 that extends in a main scanning direction and a scanning unit 42 that extends in the main scanning direction. The light source 41 is configured with, for example, a light emitting element such as a light emitting diode (LED). The scanning unit 42 is configured with, for example, a light receiving element such as a charge coupled device (CCD).

The document detection sensor 45 is configured with a sensor such as a reflective photointerrupter (also referred to as a photoreflector) including a light emitting element and a light receiving element and detects the presence or absence of the document at a facing position.

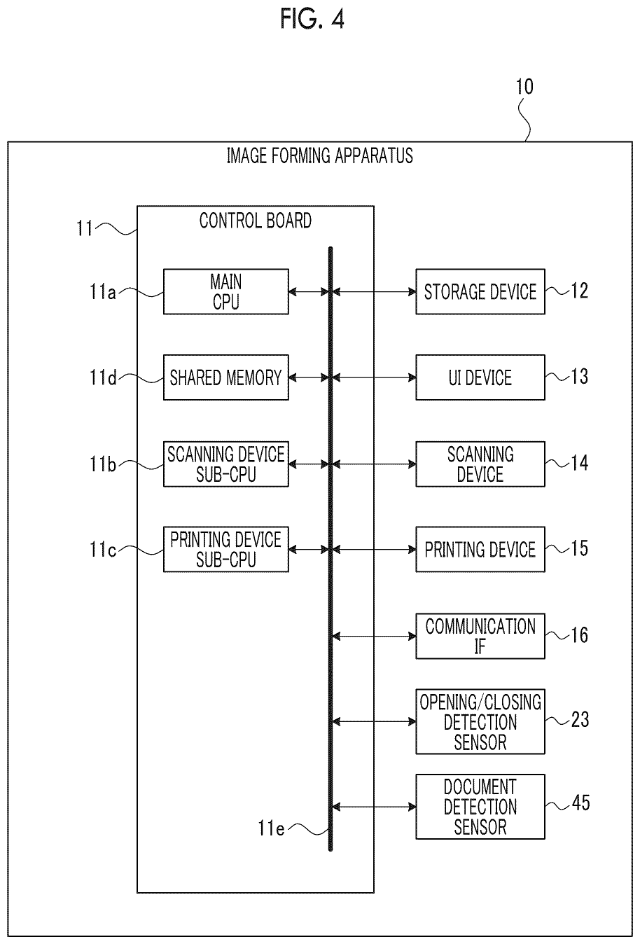

Next, a hardware configuration of the image forming apparatus 10 of the present exemplary embodiment will be described. FIG. 4 is a block diagram showing the hardware configuration of the image forming apparatus 10.

As shown in FIG. 4, the image forming apparatus 10 includes a control board 11, a storage device 12 such as a hard disk drive, a user interface (abbreviated as UI) device 13 including a touch panel or a liquid crystal display, and a keyboard, the scanning device 14, a printing device 15, a communication interface (abbreviated as IF) 16, the opening/closing detection sensor 23, and the document detection sensor 45.

The image forming apparatus 10 of the present exemplary embodiment includes the scanning device 14 and the printing device 15 as image processing units of the technology of the present disclosure.

The control board 11 is an electronic board having a function of controlling entirety of the image forming apparatus 10 and includes a main central processing unit (CPU) 11a, a scanning device sub-CPU 11b, a printing device sub-CPU 11c, a shared memory 11d, and a control bus 11e.

The main CPU 11a performs control of the entirety of the image forming apparatus 10 and startup processing of the image forming apparatus 10. The scanning device sub-CPU 11b is a processor independent of the main CPU 11a and controls the scanning device 14. The printing device sub-CPU 11c is a processor independent of the main CPU 11a and controls the printing device 15.

The shared memory 11d is a memory that is accessible in common to the main CPU 11a, the scanning device sub-CPU 11b, and the printing device sub-CPU 11c, and is configured with, for example, a random access memory (RAM).

The main CPU 11a, the scanning device sub-CPU 11b, and the printing device sub-CPU 11c are processors that execute predetermined processing based on control programs stored in the shared memory 11d or the storage device 12 to control the entirety or a part of operations of the image forming apparatus 10.

In the present exemplary embodiment, the main CPU 11a, the scanning device sub-CPU 11b, and the printing device sub-CPU 11c have been described as reading and executing the control programs stored in the shared memory 11d or the storage device 12, but the present disclosure is not limited thereto. The control program may be provided in a form of being recorded on a computer-readable recording medium. For example, the program may be provided in a form of being recorded on an optical disc such as a compact disc (CD)-read only memory (ROM) and a digital versatile disc (DVD)-ROM, or in a form of being recorded on a semiconductor memory such as a universal serial bus (USB) memory and a memory card. Additionally, the control program may be acquired from an external device via a communication line connected to the communication IF 16.

The storage device 12 is configured with a storage medium such as a hard disk drive (HDD), a solid state drive (SSD), and/or a ROM. The UI device 13 is composed of a touch panel 13a and a physical button and accepts an instruction input from a user. The touch panel 13a that constitutes a part of the UI device 13 is an example of a display unit of the image processing system in the technology of the present disclosure.

The scanning device 14 includes the carriage 40 and scans the document loaded in the image forming apparatus 10 as image data. The printing device 15 prints an image on a recording medium such as printing paper through processes such as charging, exposure, development, transfer, and fixing. The communication IF 16 transmits and receives data to and from an external device or the like.

The above components are connected to each other via the control bus 11e provided on the control board 11.

In the image forming apparatus 10, in a case where an error stop has occurred before the touch panel 13a that constitutes a part of the UI device 13 becomes usable at the startup, a notification of an error content cannot be issued through the touch panel 13a.

Therefore, in the image forming apparatus 10 of the present exemplary embodiment, the main CPU 11a records a history in the shared memory 11d for each processing in the startup processing of the image forming apparatus 10, and in a case where the startup processing by the main CPU 11a has stopped before the touch panel 13a becomes usable in the startup processing, the scanning device sub-CPU 11b or the printing device sub-CPU 11c refers to information including at least the history recorded in the shared memory 11d to issue a notification of the error content by using the scanning device 14 or the printing device 15 that are the image processing units.

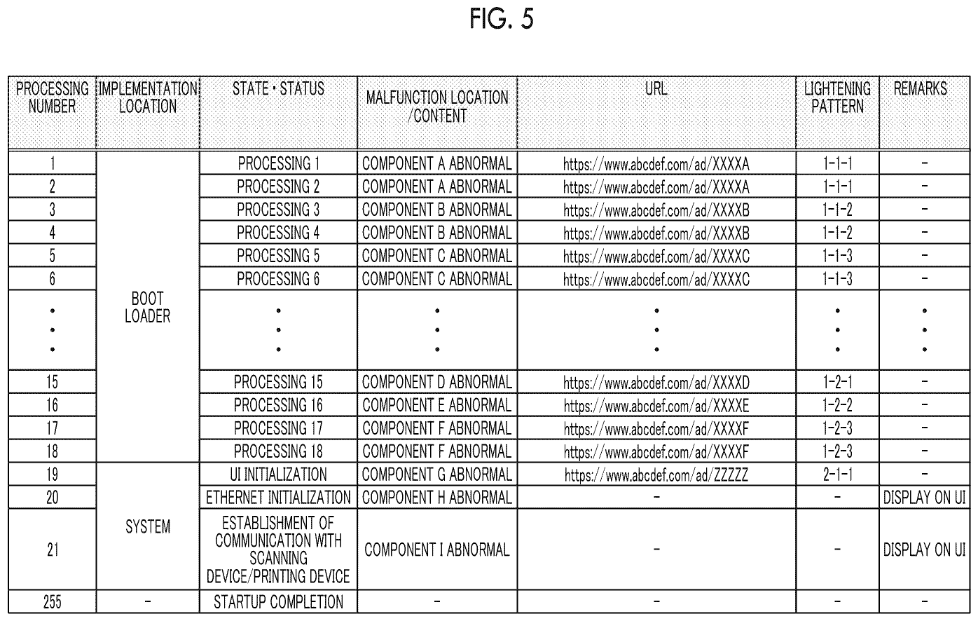

Hereinafter, the processing in the image forming apparatus 10 of the present exemplary embodiment will be described in detail. First, the startup processing will be described. FIG. 5 is a diagram showing an example of the management table for managing detailed information for each processing in the startup processing of the image forming apparatus 10.

As shown in FIG. 5, in the management table, information on “implementation location”, “state/status”, “malfunction location/content”, “uniform resource locator (URL)”, “lighting pattern”, and “remarks” is managed for each “processing number”. The management table is recorded in the shared memory 11d.

The “processing number” is a unique number allocated for each processing and corresponds to a footprint value during the recording of the history to be described below. Regardless of the number of processes, the last processing number, that is, the processing number when the startup is completed, is 255. The “implementation location” indicates a location where the processing is implemented. The “state/status” indicates a startup state in the processing or a processing content of the processing. The “malfunction location/content” indicates a malfunction location and a content in a case where an error has occurred in the processing.

The “URL” indicates a URL to be printed on the medium by the printing device 15 in a case where an error has occurred in the processing. The URL is address information for accessing a website where information regarding the error content is described. The “lighting pattern” indicates a lighting pattern for lighting up the carriage 40 of the scanning device 14, in a case where an error has occurred in the processing. The lighting pattern will be described in detail below. The “remarks” indicate a response content in a case where measures are taken in a device other than the scanning device 14 and the printing device 15, in a case where an error has occurred in the processing.

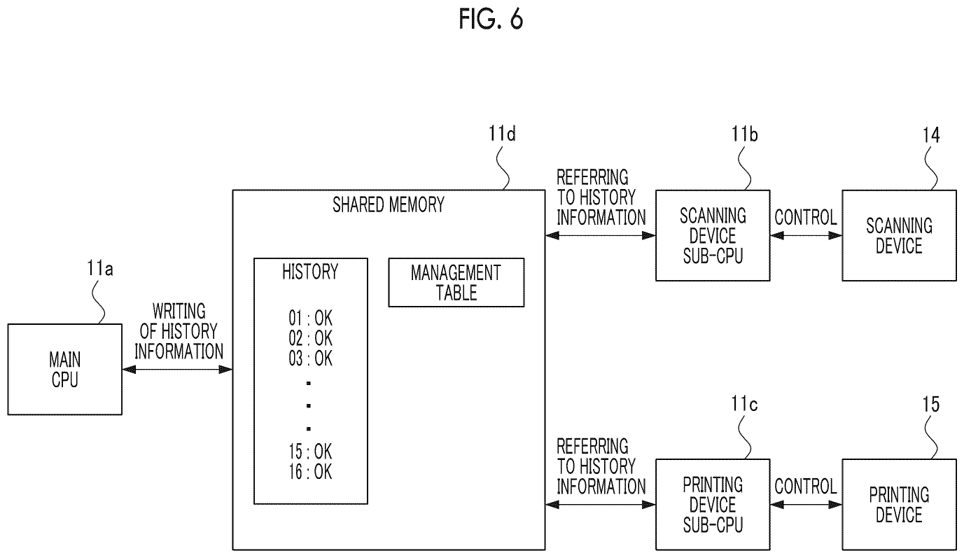

As shown in FIG. 6, in the startup processing of the image forming apparatus 10, the main CPU 11a records a processing number that has ended as the history in the shared memory 11d each time one processing ends.

In a case where the startup processing by the main CPU 11a has stopped before the touch panel 13a becomes usable in the startup processing, the scanning device sub-CPU 11b or the printing device sub-CPU 11c refers to the history and the management table recorded in the shared memory 11d to issue a notification of the error content by using the scanning device 14 or the printing device 15.

For example, in a case where a completion record up to a processing number 16 is left as the history, an error occurs in a processing number 17 that is the next processing, so that the scanning device sub-CPU 11b or the printing device sub-CPU 11c issues a notification of the error content by using the scanning device 14 or the printing device 15 in accordance with the item of the processing number 17 in the management table.

In addition, in the example shown in FIG. 6, in the startup processing, in a case where the processing for a processing number 19 of performing UI initialization is completed, the touch panel 13a for issuing a notification of the error content becomes usable. Therefore, in a case where the completion record up to the processing number 19 or subsequent processing number is left as the history, the scanning device sub-CPU 11b or the printing device sub-CPU 11c does not issue a notification of the error content, and the main CPU 11a issues a notification of the error content by using the touch panel 13a.

Next, the notification of the error content by the scanning device 14 or the printing device 15 will be described.

In a case where the startup processing by the main CPU 11a has stopped before the touch panel 13a becomes usable in the startup processing, the notification of the error content may be issued by using the scanning device 14, and in this case, the scanning device sub-CPU 11b may issue a notification of the error content by lighting up the carriage 40 provided in the scanning device 14.

In this case, the scanning device sub-CPU 11b may issue a notification of the error content by moving the carriage 40 and lighting up the carriage at a plurality of positions.

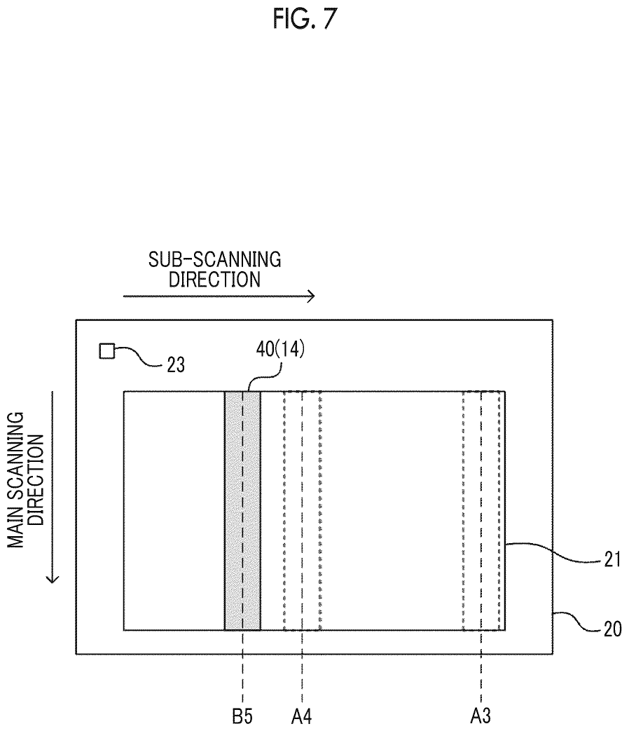

In the present exemplary embodiment, as shown in FIG. 7, the carriage 40 is moved to three positions in the sub-scanning direction, that is, a document edge position in a case of B5 being placed horizontally, a document edge position in a case of A4 being placed horizontally, and a document edge position in a case of A3 being placed horizontally, and the carriage 40 is lit up a predetermined number of times at each position, in accordance with the lighting pattern of the management table.

For example, in a case where the lighting pattern is “1-2-3”, first, the carriage 40 is moved to the document edge position in a case of B5 being placed horizontally and is lit up once, then the carriage 40 is moved to the document edge position in a case of A4 being placed horizontally and is lit up twice, and finally, the carriage 40 is moved to the document edge position in a case of A3 being placed horizontally and is lit up three times.

In addition, in a case where the startup processing by the main CPU 11a has stopped before the touch panel 13a becomes usable in the startup processing, the notification of the error content may be issued by using the printing device 15, and in this case, the printing device sub-CPU 11c may issue a notification of the error content by printing the error content on the medium through the printing device 15.

In this case, the printing device sub-CPU 11c may print the address information for accessing the website where the information regarding the error content is described, on the medium together with the error content. Examples of the address information include text information indicating a URL and/or a QR code (registered trademark) image indicating a URL.

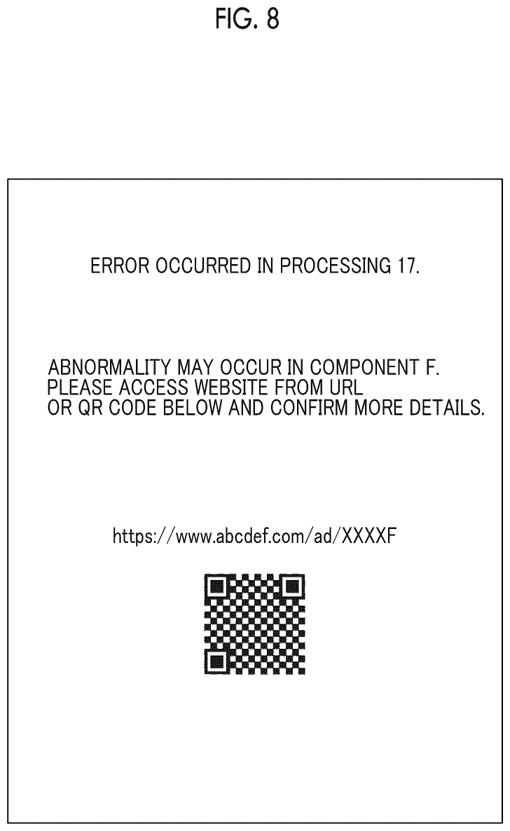

In the present exemplary embodiment, as shown in FIG. 8, as an example, the error content, the text information indicating the URL, the QR code image indicating the URL, and the like are printed on the medium. In this case, the URL may be printed as the QR code image.

In addition, in a case where the scanning device 14 and the printing device 15 are provided as the image processing units, the scanning device sub-CPU 11b may issue a notification of the error content by preferentially using the scanning device 14.

In a case where the notification of the error content is issued by using the scanning device 14, and the document platen cover 22 is not opened, the lighting of the carriage 40 cannot be visually recognized. Therefore, the scanning device sub-CPU 11b may issue a notification of the error content by using the printing device 15 in a case where the document platen cover 22 has not been opened for a set length of time or longer.

In this case, the scanning device sub-CPU 11b instructs the printing device sub-CPU 11c to issue a notification of the error content, and the printing device sub-CPU 11c issues a notification of the error content by using the printing device 15.

In addition, in a case where the scanning device 14 and the printing device 15 are provided as the image processing units, the printing device sub-CPU 11c may issue a notification of the error content by preferentially using the printing device 15.

Next, a flow of processing during the startup processing in the image forming apparatus 10 of the present exemplary embodiment will be described.

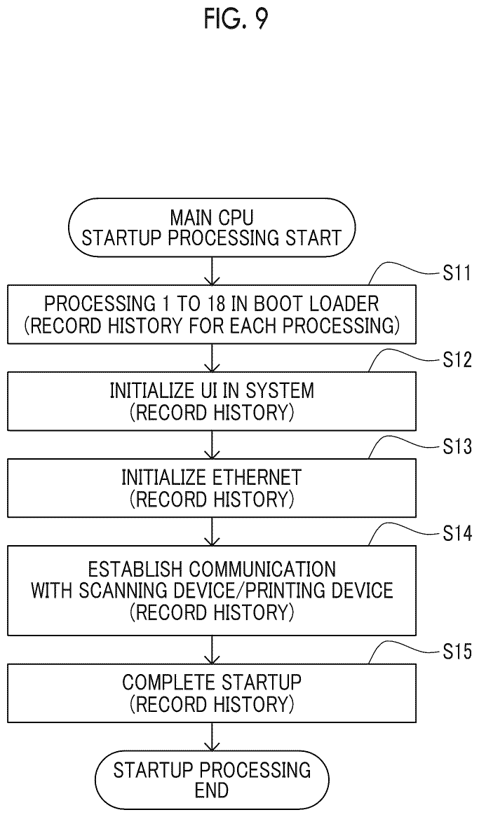

First, a flow of processing during the startup processing in the main CPU 11a will be described with reference to the flowchart of FIG. 9.

First, in step S11, the main CPU 11a executes processing 1 to processing 18 in a boot loader in order. In this case, the main CPU 11a records the processing number that has ended as the history in the shared memory 11d each time one processing ends.

Next, in step S12, the main CPU 11a executes the UI initialization in the system. In a case where the processing has ended, the main CPU 11a records the processing number 19 that has ended as the history in the shared memory 11d.

Next, in step S13, the main CPU 11a executes initialization of the Ethernet (registered trademark) in the system. In a case where the processing has ended, the main CPU 11a records the processing number 20 that has ended as the history in the shared memory 11d.

Next, in step S14, the main CPU 11a executes the establishment of the communication with the scanning device 14 and the printing device 15 in the system. In a case where the processing has ended, the main CPU 11a records the processing number 21 that has ended as the history in the shared memory 11d.

Next, in step S15, the main CPU 11a completes the startup, records the processing number 255 as the history in the shared memory 11d, and ends the startup processing.

In a case where any error has occurred in the startup processing, the main CPU 11a stops the startup processing at a stage in which the error has occurred. In this case, in a case where the UI initialization in step S12 has been completed, the main CPU 11a issues a notification of the error content by using the touch panel 13a.

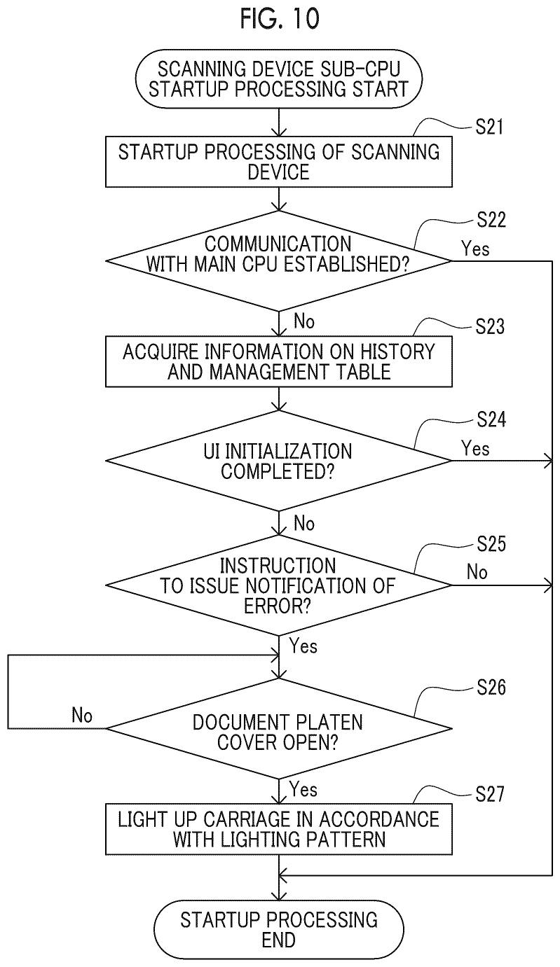

Next, a flow of processing in the scanning device sub-CPU 11b during the startup processing will be described with reference to the flowchart of FIG. 10.

First, in step S21, the scanning device sub-CPU 11b performs the startup processing of the scanning device 14.

Next, in step S22, the scanning device sub-CPU 11b determines whether or not the communication with the main CPU 11a has been established.

In step S22, in a case where the scanning device sub-CPU 11b determines that the communication with the main CPU 11a has been established, the scanning device sub-CPU 11b ends the startup processing.

In step S22, in a case where the scanning device sub-CPU 11b determines that the communication with the main CPU 11a has not been established, the scanning device sub-CPU 11b acquires the information on the history and the management table recorded in the shared memory 11d in step S23.

Next, in step S24, the scanning device sub-CPU 11b determines whether the UI initialization has been completed, that is, whether or not the processing number 19 has been recorded in the history.

In step S24, in a case where the scanning device sub-CPU 11b determines that the UI initialization has been completed, the scanning device sub-CPU 11b ends the startup processing.

In step S24, in a case where the scanning device sub-CPU 11b determines that the UI initialization has not been completed, the scanning device sub-CPU 11b determines in step S25 whether or not the instruction to issue a notification of the error content has been input from the scanning device 14 in a case of error occurrence.

In step S25, in a case where the scanning device sub-CPU 11b determines that no instruction has been input, the scanning device sub-CPU 11b ends the startup processing.

In step S25, in a case where the scanning device sub-CPU 11b determines that the instruction has been input, the scanning device sub-CPU 11b determines in step S26 whether or not the document platen cover 22 is open.

In step S26, in a case where the scanning device sub-CPU 11b determines that the document platen cover 22 is not open, the scanning device sub-CPU 11b waits until the document platen cover 22 is opened.

In step S26, in a case where the scanning device sub-CPU 11b determines that the document platen cover 22 is open, in step S27, the scanning device sub-CPU 11b refers to the history to specify the processing number in which the error has occurred, refers to the management table to acquire the lighting pattern in the processing number, lights up the carriage 40 in accordance with the lighting pattern, and ends the startup processing.

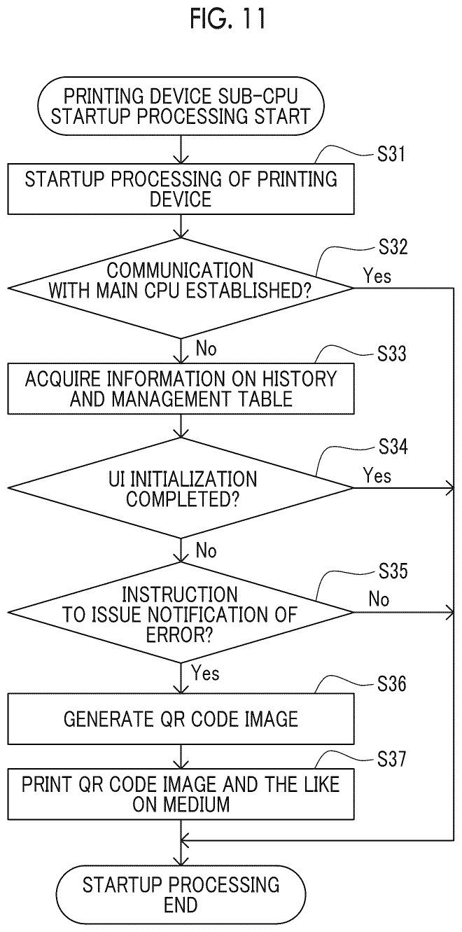

Next, a flow of processing in the printing device sub-CPU 11c during the startup processing will be described with reference to the flowchart of FIG. 11.

First, the printing device sub-CPU 11c performs the startup processing of the printing device 15 in step S31.

Next, in step S32, the printing device sub-CPU 11c determines whether or not the communication with the main CPU 11a has been established.

In step S32, in a case where the printing device sub-CPU 11c determines that the communication with the main CPU 11a has been established, the printing device sub-CPU 11c ends the startup processing.

In step S32, in a case where the printing device sub-CPU 11c determines that the communication with the main CPU 11a has not been established, the printing device sub-CPU 11c acquires the information on the history and the management table recorded in the shared memory 11d in step S33.

Next, in step S34, the printing device sub-CPU 11c determines whether the UI initialization has been completed, that is, whether or not the processing number 19 has been recorded in the history.

In step S34, in a case where the printing device sub-CPU 11c determines that the UI initialization has been completed, the printing device sub-CPU 11c ends the startup processing.

In step S34, in a case where the printing device sub-CPU 11c determines that the UI initialization has not been completed, the printing device sub-CPU 11c determines in step S35 whether or not the instruction to issue a notification of the error content has been input from the printing device 15 in a case of error occurrence.

In step S35, in a case where the printing device sub-CPU 11c determines that no instruction has been input, the printing device sub-CPU 11c ends the startup processing.

In step S35, in a case where the printing device sub-CPU 11c determines that the instruction has been input, in step S36, the printing device sub-CPU 11c refers to the history to specify the processing number in which the error has occurred, refers to the management table to acquire the URL for the processing number, and creates the QR code image in accordance with the URL.

Next, in step S37, the printing device sub-CPU 11c prints the error content, the text information indicating the URL, the QR code image created in step S36, and the like on the medium, and ends the startup processing.

### Modification Examples

Although the image processing system of one exemplary embodiment of the present invention has been described above, the present invention is not limited to the above exemplary embodiment and can also be changed as appropriate.

In the above exemplary embodiment, the “system” includes both a system configured with a plurality of devices and a system configured with a single device.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, with regard to the sub-processor, there is no need to individually provide the scanning device sub-CPU 11b for controlling the scanning device 14 and the printing device sub-CPU 11c for controlling the printing device 15, and the scanning device 14 and the printing device 15 may be controlled by a single sub-processor.

### Supplementary Note

Regarding the exemplary embodiment described above, the following supplementary notes are further disclosed.

(((1)))

An image processing system comprising:
an image processing unit including at least one of a scanning device that scans an image or a printing device that prints the image on a medium;
a display unit that displays a screen;
a main processor;
a sub-processor configured to perform control of the image processing unit independently of the main processor; and
a shared memory that is accessible in common to the main processor and the sub-processor,
wherein the main processor is configured to record a history in the shared memory for each processing in startup processing of the image processing system, and
the sub-processor is configured to, in a case where the startup processing by the main processor has stopped before the display unit becomes usable in the startup processing, refer to information including at least the history recorded in the shared memory to issue a notification of an error content by using the image processing unit.
   (((2)))

The image processing system according to (((1))
wherein the image processing unit includes the scanning device, and
the sub-processor is configured to issue a notification of the error content by lighting up a carriage provided in the scanning device in a case where the startup processing by the main processor has stopped before the display unit becomes usable in the startup processing.
   (((3)))

The image processing system according to (((2))
wherein the sub-processor is configured to issue a notification of the error content by moving the carriage and lighting up the carriage at a plurality of positions.
   (((4)))

The image processing system according to (((1))),
wherein the image processing unit includes the printing device, and
the sub-processor is configured to issue a notification of the error content by printing the error content on the medium through the printing device in a case where the startup processing by the main processor has stopped before the display unit becomes usable in the startup processing.
   (((5)))

The image processing system according to (((4))),
wherein the sub-processor is configured to print address information for accessing a website where information regarding the error content is described, on the medium together with the error content.
   (((6)))

The image processing system according to any one of (((1))) to (((5))),
wherein the image processing unit includes the scanning device and the printing device, and
the sub-processor is configured to issue a notification of the error content by using the scanning device in a case where the startup processing by the main processor has stopped before the display unit becomes usable in the startup processing.
   (((7)))

The image processing system according to (((6))),
wherein the scanning device includes a document platen on which a document is placed and a document platen cover capable of covering the document platen, and
the sub-processor is configured to issue a notification of the error content by using the printing device in a case where the document platen cover has not been opened for a set length of time or longer in issuing a notification of the error content.
   (((8)))

The image processing system according to any one of (((1))) to (5)
wherein the image processing unit includes the scanning device and the printing device, and
the sub-processor is configured to issue a notification of the error content by using the printing device in a case where the startup processing by the main processor has stopped before the display unit becomes usable in the startup processing.
   (((9)))

A program for controlling an image processing system including an image processing unit that includes at least one of a scanning device that scans an image or a printing device that prints the image on a medium, a display unit that displays a screen, a main processor, a sub-processor configured to perform control of the image processing unit independently of the main processor, and a shared memory that is accessible in common to the main processor and the sub-processor, the program causing a computer to execute:
in the main processor, recording a history in the shared memory for each processing in startup processing of the image processing system; and
in the sub-processor, in a case where the startup processing by the main processor has stopped before the display unit becomes usable in the startup processing, referring to information including at least the history recorded in the shared memory to issue a notification of an error content by using the image processing unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing system comprising:
an image processing unit including at least one of a scanning device that scans an image or a printing device that prints the image on a medium;
a display unit that displays a screen;
a main processor;
a sub-processor configured to perform control of the image processing unit independently of the main processor; and
a shared memory that is accessible in common to the main processor and the sub-processor,
wherein the main processor is configured to record a history in the shared memory for each processing in startup processing of the image processing system, and
the sub-processor is configured to, in a case where the startup processing by the main processor has stopped before the display unit becomes usable in the startup processing, refer to information including at least the history recorded in the shared memory to issue a notification of an error content by using the image processing unit.

2. The image processing system according to claim 1,
wherein the image processing unit includes the scanning device, and
the sub-processor is configured to issue a notification of the error content by lighting up a carriage provided in the scanning device in a case where the startup processing by the main processor has stopped before the display unit becomes usable in the startup processing.

3. The image processing system according to claim 2,
wherein the sub-processor is configured to issue a notification of the error content by moving the carriage and lighting up the carriage at a plurality of positions.

4. The image processing system according to claim 1,
wherein the image processing unit includes the printing device, and
the sub-processor is configured to issue a notification of the error content by printing the error content on the medium through the printing device in a case where the startup processing by the main processor has stopped before the display unit becomes usable in the startup processing.

5. The image processing system according to claim 4,
wherein the sub-processor is configured to print address information for accessing a website where information regarding the error content is described, on the medium together with the error content.

6. The image processing system according to claim 1,
wherein the image processing unit includes the scanning device and the printing device, and
the sub-processor is configured to issue a notification of the error content by using the scanning device in a case where the startup processing by the main processor has stopped before the display unit becomes usable in the startup processing.

7. The image processing system according to claim 6,
wherein the scanning device includes a document platen on which a document is placed and a document platen cover capable of covering the document platen, and
the sub-processor is configured to issue a notification of the error content by using the printing device in a case where the document platen cover has not been opened for a set length of time or longer in issuing a notification of the error content.

8. The image processing system according to claim 1,
wherein the image processing unit includes the scanning device and the printing device, and
the sub-processor is configured to issue a notification of the error content by using the printing device in a case where the startup processing by the main processor has stopped before the display unit becomes usable in the startup processing.

9. A non-transitory computer readable medium storing a program for controlling an image processing system including an image processing unit that includes at least one of a scanning device that scans an image or a printing device that prints the image on a medium, a display unit that displays a screen, a main processor, a sub-processor configured to perform control of the image processing unit independently of the main processor, and a shared memory that is accessible in common to the main processor and the sub-processor, the program causing a computer to execute:
in the main processor, recording a history in the shared memory for each processing in startup processing of the image processing system; and
in the sub-processor, in a case where the startup processing by the main processor has stopped before the display unit becomes usable in the startup processing, referring to information including at least the history recorded in the shared memory to issue a notification of an error content by using the image processing unit.

10. An image processing method for controlling an image processing system including an image processing unit that includes at least one of a scanning device that scans an image or a printing device that prints the image on a medium, a display unit that displays a screen, a main processor, a sub-processor configured to perform control of the image processing unit independently of the main processor, and a shared memory that is accessible in common to the main processor and the sub-processor, the image processing method comprising:
in the main processor, recording a history in the shared memory for each processing in startup processing of the image processing system; and
in the sub-processor, in a case where the startup processing by the main processor has stopped before the display unit becomes usable in the startup processing, referring to information including at least the history recorded in the shared memory to issue a notification of an error content by using the image processing unit.
